(19) United States
(12) Patent Application Publication
(10) Pub. No.: US 2024/0233014 A1
(43) Pub. Date: Jul. 11, 2024

(54) MACHINE LEARNING ENABLED ALGORITHMIC TRADING

(71) Applicant: THOMAS COLEMAN, GREENVILLE, SC (US)

(72) Inventor: THOMAS COLEMAN, GREENVILLE, SC (US)

(21) Appl. No.: 18/095,012

(22) Filed: Jan. 10, 2023

(51) Int. Cl. G06Q 40/04

(52) U.S. Cl. CPC G06Q 40/04

(57) ABSTRACT

The present invention provides a machine learning enabled algorithmic trading system. More specifically, the trading system herein is capable of changing requested trades of any asset type or combinations thereof based upon dynamic trading conditions either before or after a trade is initiated by a user.

### FIELD OF THE INVENTION

The present invention provides a machine learning enabled algorithmic trading system for the trading of one or more types of securities. More specifically, the trading system herein is capable of changing requested trades of any asset type or combinations thereof based upon dynamic trading conditions either before or after a trade is initiated by a user.

### BACKGROUND OF THE INVENTION

The world of online trading has greatly advanced since the advent of its use on the internet. In modern times, many entities now strive to “dummy proof” securities trading by providing automated or semi-automated trading programs which are typically web based.

These web based trading platforms either a) provide an interface by which a user can select and execute trades upon selectable securities and/or additionally provide a way for a trading platform (i.e., an algorithmic trading platform) that executes trades as instructed by a user based upon pre-programmed profit/loss criteria.

Typically, the available algorithmic trading platforms are simple profit/loss engines but may also monitor market conditions in real time to effect trades to either maximize profit or minimize loss. Also typically, these modern trading platforms execute trades through a pre-selected trading strategy and are usually limited to one type of security to trade at a time.

These modern trading platforms, whether simple or algorithmic, do not have the ability to respond to dynamic market conditions as they happen beyond selling a security to secure profit or mitigate against loss. They certainly do not have the ability to autonomously either a) choose a new security or securities to maximize profit or mitigate loss post the choosing of a first security (or securities) and/or b) change strategies either before or after a security or securities have been chosen to maximize profit or mitigate loss.

The disclosed inventions herein therefore provide embodiments for a semi-autonomous algorithmic trading platform that enable a trader to semi-autonomously a) choose a new security or securities to maximize profit or mitigate loss after the choosing of a first security (or securities) and/or b) change strategies either before or after a security or securities have been chosen to maximize profit or mitigate loss.

### SUMMARY OF THE INVENTION

Accordingly, the invention provides a system for machine learning enabled algorithmic trading before and after a trade has been executed using a computerized device. The system comprises a user-friendly software interface on the computerized device wherein the software interface enables multi-asset selection for algorithmic trading. The computerized device may either be a mobile device or a personal computer (e.g., laptop or desk top) for use by a user.

The system further comprises at least one computer grade server having a first algorithm for algorithmic trading. The computerized device is preferably in untethered communication with the at least one computer grade server. Also, a second algorithm is positioned onto the at least one computer grade server.

In practice, the second algorithm performs the following steps, comprising:
i. Identifying the trend of a current market direction;
ii. Choosing one or multiple of securities to trade;
iii. Identifying multiple trade options;
iv. Employing a machine learning engine for examining trend line motions of one or more subject securities having the steps of;
   1. Collecting market data;
   2. Forming a data set from the collected market data;
   3. Producing an estimate about a pattern in the data set;
   4. Making a prediction about the data set;
   5. Evaluating the prediction;
   6. Optimizing the prediction for accuracy;
v. Producing a stop/loss target for each trade option based upon optimized prediction;
vi. Calculating a profit analysis for each multiple trade option; and
vii. Choosing one or more of the multiple trade options to execute a trade of the security or securities within the system.

The system may further comprise a third algorithm wherein the third algorithm continually monitors post trade market conditions of a chosen security or securities. The third algorithm calculates a new stop/loss target based upon varying or dynamic market conditions. If the third algorithm calculates a new stop/loss target, the second algorithm autonomously executes a trade based upon said new stop/loss target calculated by said third algorithm.

In one embodiment herein, a user chooses one or more assets to be traded. The user also chooses a trading strategy for trading one or more kinds of securities. In operation, the said second algorithm chooses one or more assets to be traded based upon the trading strategy.

The system has the ability to autonomously or semi-autonomously self-adjust it choice(s) of security and/or trading strategy based upon past and current market performance irrespective of a user's (i.e., trader's) initial selections of either. In practice, the system tracks and records each trade and attendant market condition for each trade as historical data and stores the historical data to memory in one or more computer grade servers. The system can then reference the historical data for future evaluation for future trades by the system.

With all of the collected data and review of publicly available trading data, the system of self-adjusting algorithmic trading learns and adapts without following explicit user instructions. The system can also autonomously or semi-autonomously create one or more trading strategies for the chosen security or securities. Once created, the system can make trades according to the created trading strategy for the chosen security or securities.

The system of semi-autonomous algorithmic trading constantly monitors dynamic market conditions before and after a trade has been executed. Before initiating a trade, the system receives a first optimal profit target from a user prior to execution of the trade or trades. The system next then autonomously calculates a second optimal profit target prior to execution of the trade or trades based upon the dynamic market conditions.

Once the second optimal profit target has been calculated, it then autonomously alters timing of a trade to achieve the second optimal profit prior to its execution based upon dynamic market conditions. But also, the system can autonomously calculate a second optimal profit target after execution of the trade or trades based upon dynamic market conditions. After execution of the first trade (by a user), the system autonomously executes a second trade to achieve the second optimal profit after execution of the system's first trade based upon dynamic market conditions.

In all instances of trading, the system is self-learning. In most instances herein, the system operates based upon both user trade inputs and machine learning. The system is also capable of creating multiple trading strategies prior to initial trade execution (i.e., at least one) based upon dynamic market conditions for a chosen security or securities. Prior to execution of the first trade, a user initially chooses one of the multiple trading strategies with which to trade prior to execution of a trade.

The system has a fourth algorithm that chooses between the multiple trading strategies after a user chooses the initial trading strategy from amongst the multiple trading strategies. In practice, the system constantly monitors varying market conditions after the trade has been executed. It also continually calculates an optimal profit based upon dynamic market conditions. The system may autonomously alter an executed trade based upon a newly calculated optimal profit and a new trading strategy chosen by the fourth algorithm. The system is self-learning.

### BRIEF DESCRIPTION OF THE FIGURES

The various exemplary embodiments of the present invention, which will become more apparent as the description proceeds, are described in the following detailed description in conjunction with the accompanying drawings, in which:

FIG. 1 is a schematic of the inventive system herein; and

FIG. 2 is a schematic of the machine learning engine used in the inventive system of FIG. 1.

### DETAILED DESCRIPTION OF THE INVENTION

The following description is provided as an enabling teaching of the present systems, and/or methods in its best, currently known aspect. To this end, those skilled in the relevant art will recognize and appreciate that many changes can be made to the various aspects of the present systems, and/or methods described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The term “security” or “securities” as used herein means . . . .

By the term “autonomous” it is meant herein

By the term “autonomously executes” it is meant herein that the system, without specific or direct user direction, executes a trade given . . . .

By the term “machine learning” it is meant herein the use and development of computer systems that are able to learn and adapt without following explicit instructions, by using algorithms and statistical models to analyze and draw inferences from patterns in data.

By the term “semi-autonomously” or “semi-autonomous” describes a system herein requiring minimal human input or supervision for the operation of the algorithmic trading once it is initiated to make a trade or trades.

By the term “bot” it is meant herein an autonomous program on the internet, another network or software program that can interact with systems or users without direct human supervision or intervention.

As used throughout, the singular forms “a,” “an” and “the” include plural referents unless the context clearly dictates otherwise. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods.

Thus, if there are a variety of additional steps that can be performed it is understood that each of these additional steps can be performed with any specific aspect or combination of aspects of the disclosed methods.

The invention herein provides a system for semi-autonomous algorithmic trading before and after a trade has been executed on at least one computerized device using machine learning. The system comprises a user-friendly software interface (i.e., “application” or “app”) on the computerized device wherein the software interface enables multi-asset selection for algorithmic trading. The computerized device may either be a mobile device or a personal computer (e.g., laptop or desk top) for use by a user.

Typical examples of computerized devices herein are IPHONES®, SAMSUNG GALAXY® and other similarly situated cell phones that have user interactive screens and applications (i.e., “apps”) loaded thereon from which, for example, choices about securities for trading can be made. By the term “app” or “apps” it is meant herein an application, especially as downloaded by a user to a mobile device.

The system further comprises at least one computer grade server having non-transitory memory installed thereon. Within the non-transitory memory is at least a first algorithm useful for algorithmic trading. The first algorithm may also be referred herein as a “bot”. The computerized device is preferably in untethered communication with the at least one computer grade server. Also, a second algorithm is positioned onto the at least one computer grade server.

By the term “untethered communication” it is meant herein that the computerized device herein is wirelessly connected to the at least one computer grade server. Wired connection is unnecessary, but possible in some alternative embodiments herein.

In practice, the second algorithm performs the following steps, comprising:
i. Identifying the trend of a current market direction;
ii. Choosing one or multiple of securities to trade;
iii. Identifying multiple trade options;
iv. Employing a machine learning engine for examining trend line motions of one or more subject securities having the steps of;
   1. Collecting market data;
   2. Forming a data set from the collected market data;
   3. Producing an estimate about a pattern in the data set;
   4. Making a prediction about the data set;
   5. Evaluating the prediction;
   6. Optimizing the prediction for accuracy;
v. Producing a stop/loss target for each trade option based upon optimized prediction;
vi. Calculating a profit analysis for each multiple trade option; and
vii. Choosing one or more of the multiple trade options to execute a trade of the security or securities within the system.

Importantly, the system autonomously identifies the trends of dynamic market conditions, which it also monitors continuously and autonomously during the life of a trade (i.e., from the time that a prospective trade is requested by a human user (i.e., trader) until the time that the trade finally sold and/or liquidated from a trader's portfolio.

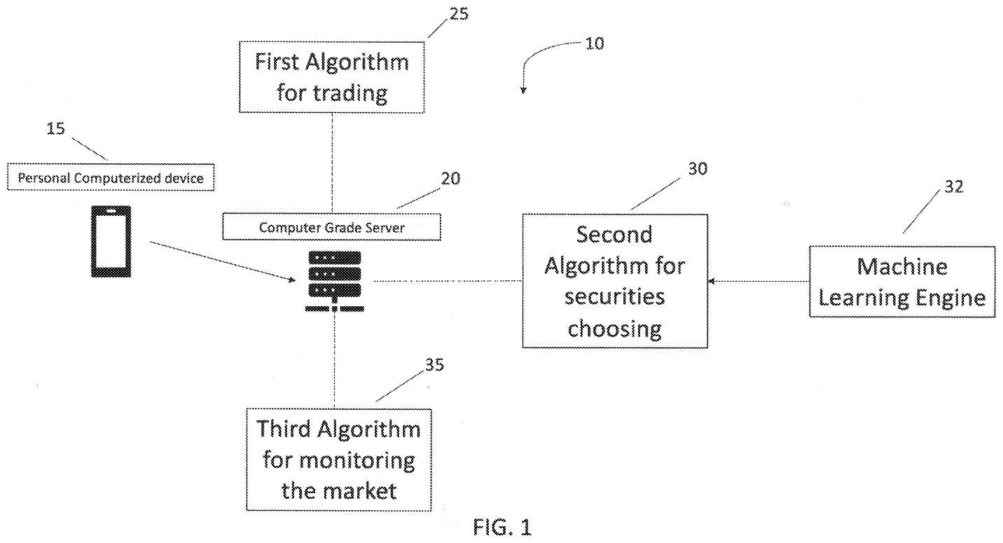

FIG. 1 provides a schematic of the inventive system 10 herein. System 10 is a machine learning enabled system by which security trades may be made. In practice, a user possesses a personal computerized device 15. The personal computerized device 15 may be a cell phone, computerized pad device, laptop or personal computer. Persons of skill in the art will readily recognize the various kinds of computerized devices available to a user under anyone of the various brand types; e.g., APPLE®, IPHONE®, ANDROID®, DELL®, SAMSUNG®, and the like.

Personal computerized device 15 (i.e., PCD 15) operatively connects to computer grade server 20 (i.e., server 20). Server 20 comprises, overall, the programming by which system 10 operates. Server 20 comprises at least one processor, preferably several, that are installed therein. One type of program that is stored on the non-transitory memory herein is operating software by which server 20 operates and, preferably, may be contacted by personal computerized device 15. Also installed is non-transitory memory by which data, instructions and programs are stored.

Another program stored within server 20's non-transitory memory is first algorithm 25. First algorithm 25 is the program within system 10 that enables a user to trade one or more kinds of securities. Importantly, system 10 is not limited to one security in a trade. System 10 can choose and then initiate multiple securities in a trade and/or initiate and execute multiple trades which include multiple securities and security types. It is shown in dotted line relationship to server 20 which is meant herein to indicate its operative connection to server 20.

Second algorithm 30 is responsible for choosing securities not originally chosen by a user, i.e., system 10 selected securities. Second algorithm 30 employs machine learning engine 32, which is a program within second algorithm 30. Machine learning engine 32 collects market data, forms data sets from the collected market data, examines the data sets for trends, produces estimates in behavior from the data sets, makes one or more predictions from the data sets, evaluates the predictions based upon one or more statistical analytical tools, and then optimizes each created prediction (i.e., there can be more than one) for accuracy thereof. It is shown in dotted line relationship to server 20 which is meant herein to indicate its operative connection to server 20.

If a prediction herein is validated by machine learning engine 32, one or more recommendations for additional trades are produced by which a) a user can choose to execute a different or additional trade (i.e., semi-autonomous operation of system 10 by a user) or b) system 10 can autonomously make the one or more recommended trades on behalf of a user without the user's specific direction (i.e., autonomous operation of system 10 by a user).

Third algorithm 35 is the algorithm responsible for monitoring the various securities markets and sending that data to server 20 for storage. Like the previous discussed algorithms, it is stored onto the nontransitory memory of server 20. It is shown in dotted line relationship to server 20 which is meant herein to indicate its operative connection to server 20.

To be clear, first algorithm 25, second algorithm 30, machine learning engine 32 and third algorithm 35 are presented as separate and distinct parts of system 10 and particularly, server 20. This may be an actual render, but it may also be a design choice. Another design choice herein is that each algorithm noted herein are parts of one complete, entire program rather three or more distinct ones. The articulation of the programs either as distinct or unified into one is a matter of design choice by persons of skill in the art.

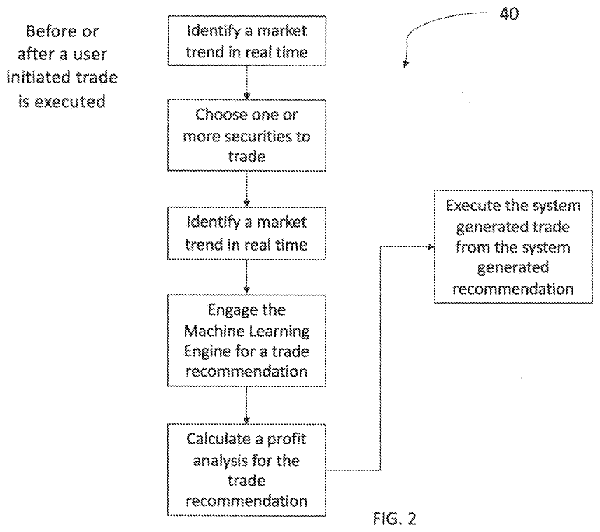

FIG. 2 is a schematic of process 40 used in inventive system 10 of FIG. 1. In practice, system 10 identifies market trends in real time. Through its machine learning engine 32, system 10 then chooses one or more additional securities to trade. This can happen a) before a user executes a trade order or b) after a user executes a trade order. Regardless of timing of user trade initiation, system 10 works to identify market trends, again, through machine learning engine 32. Importantly, machine learning engine 32

In practice, raw market data flows from third algorithm 35 into the non-transitory memory housed within server 20 and is then treated and segregated by machine learning engine 32. Once the raw data is collected, machine learning engine 32 then goes about the business of producing an estimate about a pattern in the data set. In other words, machine learning engine 32 looks for patterns in the raw data and logs them. At the production of the estimate, machine learning engine 32 makes one or multiple predictions about the trend of the data.

Before the prediction is relied upon to execute action by system 10, it can be evaluated by machine learning engine 32. Methods of evaluation are statistical and can include classification accuracy, algorithmic loss, confusion matrix, area under curve, F1 score, mean absolute error, and mean squared error.

Classification accuracy is what is usually meant by the term “accuracy”. It is the ratio of number of correct predictions to the total number of input samples. Log-loss is indicative of how close the prediction probability is to the corresponding actual/true value (0 or 1 in case of binary classification). The more the predicted probability diverges from the actual value, the higher is the log-loss value. A confusion matrix is a table that is used to define the performance of a classification algorithm. A confusion matrix visualizes and summarizes the performance of a classification algorithm.

Area Under Curve (AUC) is one of the most widely used metrics for evaluation. It is used for binary classification problem. AUC of a classifier is equal to the probability that the classifier will rank a randomly chosen positive example higher than a randomly chosen negative example. F1 Score is the Harmonic Mean between precision and recall. The range for F1 Score is [0, 1]. It tells one how precise a known classifier is (i.e., how many instances it classifies correctly), as well as how robust it is—it does not miss a significant number of instances. Mean absolute error is the average of the difference between the original values and the predicted values. It provides the measure of how far the predictions were from the actual output. However, they do not provide any idea of the direction of the error, i.e., whether the system under predicts the data or over predicts the data.

Once all predictions for all measurables (e.g., water level, nutrient level, lighting levels, temperature, humidity, and the like) have been evaluated, the next step is to optimize the predictions for use. “Prediction” refers to the output of an algorithm after it has been trained on a historical dataset and applied to new data when forecasting the likelihood of a particular outcome.

The system may further comprise a third algorithm wherein the third algorithm continually monitors post trade market conditions of a chosen security or securities. The third algorithm calculates a new stop/loss target based upon varying or dynamic market conditions. If the third algorithm calculates a new stop/loss target, the second algorithm autonomously executes a trade based upon said new stop/loss target calculated by said third algorithm.

In one embodiment herein, a user chooses one or more assets to be traded. The user also chooses a trading strategy for trading one or more kinds of securities. In operation, the said second algorithm chooses one or more assets to be traded based upon the trading strategy.

The system has the ability to autonomously or semi-autonomously self-adjust it choice(s) of security and/or trading strategy based upon past and current market performance irrespective of a user's (i.e., trader's) initial selections of either. In practice, the system tracks and records each trade and attendant market condition for each trade as historical data and stores the historical data to memory in one or more computer grade servers. The system can then reference the historical data for future evaluation for future trades by the system.

With all of the collected data and review of publicly available trading data, the system of self-adjusting algorithmic trading learns and adapts without following explicit user instructions. The system can also autonomously or semi-autonomously create one or more trading strategies for the chosen security or securities. Once created, the system can make trades according to the created trading strategy for the chosen security or securities.

The system of semi-autonomous algorithmic trading constantly monitors dynamic market conditions before and after a trade has been executed. Before initiating a trade, the system receives a first optimal profit target from a user prior to execution of the trade or trades. The system next then autonomously calculates a second optimal profit target prior to execution of the trade or trades based upon the dynamic market conditions.

Once the second optimal profit target has been calculated, it then autonomously alters timing of a trade to achieve the second optimal profit prior to its execution based upon dynamic market conditions. But also, the system can autonomously calculate a second optimal profit target after execution of the trade or trades based upon dynamic market conditions. After execution of the first trade (by a user), the system autonomously executes a second trade to achieve the second optimal profit after execution of the system's first trade based upon dynamic market conditions.

In all instances of trading herein, the system is self-learning. In most instances herein, the system operates based upon both user trade inputs and machine learning. The system is also capable of creating multiple trading strategies prior to initial trade execution (i.e., at least one) based upon dynamic market conditions for a chosen security or securities. Prior to execution of the first trade, a user initially chooses one of the multiple trading strategies with which to trade prior to execution of a trade.

The system has a fourth algorithm that chooses between the multiple trading strategies after a user chooses the initial trading strategy from amongst the multiple trading strategies. In practice, the system constantly monitors varying market conditions after the trade has been executed. It also continually calculates an optimal profit based upon dynamic market conditions. The system may autonomously alter an executed trade based upon a newly calculated optimal profit and a new trading strategy chosen by the fourth algorithm. The system is self-learning.

Semi-autonomous operation of system 10 herein means that the system self-adjusts and executes commands without human intervention. System 10's self-adjustment derives from optimization of the prediction(s) created by machine learning engine 22. At optimization of the prediction(s) for accuracy, system 10 next produces one or more commands for adjustment to system 10. Ideally, system 10 is at least partially self-governing but not self-actuating. By self-governing it is meant that system 10 can continuously evaluate itself and issue commands (or make recommendations) for action. By self-actuating it is meant herein that system 10 can itself execute commands generated from its calculated optimized predictions but in the instance in which system 10 is semi-autonomous, a user can execute command recommendations created proffered by machine learning engine 22.

The system has the ability to autonomously or semi-autonomously self-adjust it choice(s) based upon past and current securities market performance and/or criteria. In practice, the system tracks and records all data generated from real time market and/or historical data all of which information is stored to memory in one or more computer grade servers. The system can then reference the historical data for future evaluation of optimal market trades by system 10 herein.

It should be appreciated and understood that the present invention may be embodied as systems, methods, apparatus, computer readable media, non-transitory computer readable media and/or computer program products. The present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” The present invention may take the form of a computer program product embodied in one or more computer readable medium(s) having computer readable program code embodied thereon.

One or more computer readable medium(s) may be utilized, alone or in combination. The computer readable medium may be a computer readable storage medium or a computer readable signal medium. A suitable computer readable storage medium may be, for example, but not limited to, an electronic, magnetic, optical, electromagnetic, infrared, or semiconductor system, apparatus, or device, or any suitable combination of the foregoing. Other examples of suitable computer readable storage medium include, without limitation, the following: an electrical connection having one or more wires, a portable computer diskette, a hard disk, a random access memory (RAM), a read-only memory (ROM), an erasable programmable read only memory (EPROM or flash memory), an optical fiber, an optical storage device, a magnetic storage device, or any suitable combination of the foregoing. A suitable computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Python, C++ or the like and conventional procedural programming languages, such as the “C” programming language or similar programming languages. The program code may execute entirely on the user's computing device (such as, a computer), partly on the user's computing device, as a stand-alone software package, partly on the user's computing device and partly on a remote computing device or entirely on the remote computing device or server. In the latter scenario, the remote computing device may be connected to the user's computing device through any type of network, including a local area network (LAN) or a wide area network (WAN), or the connection may be made to an external computing device (for example, through the Internet using an Internet Service Provider).

The present invention is described herein with reference to flowchart illustrations and/or block diagrams, can be implemented by computer program instructions. These computer program instructions may be provided to a processor of a general purpose computing device (such as, a computer), special purpose computing device, or other programmable data processing apparatus to produce a machine, such that the instructions, which execute via the processor of the computing device or other programmable data processing apparatus, create means for implementing the functions/acts specified in the flowchart and/or block diagram block or blocks.

These computer program instructions may also be stored in a computer readable medium that can direct a computing device, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computing device, other programmable apparatus or other devices to produce a computer implemented process such that the instructions which execute on the computing device or other programmable apparatus provide processes for implementing the functions/acts specified in the flowchart and/or block diagram block or blocks.

It should be appreciated that the function blocks or modules shown in the drawings illustrate the architecture, functionality, and operation of possible implementations of systems, methods and computer program media and/or products according to various embodiments of the present invention. In this regard, each block in the drawings may represent a module, segment, or portion of code, which comprises one or more executable instructions for implementing the specified logical function(s). It should also be noted that, in some alternative implementations, the functions noted in the block may occur out of the order noted in the figures. For example, the function of two blocks shown in succession may, in fact, be executed substantially concurrently, or the blocks may sometimes be executed in the reverse order, depending upon the functionality involved.

It will also be noted that each block and combinations of blocks in any one of the drawings can be implemented by special purpose hardware-based systems that perform the specified functions or acts, or combinations of special purpose hardware and computer instructions. Also, although communication between function blocks or modules may be indicated in one direction on the drawings, such communication may also be in both directions.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A machine learning enabled system for algorithmic trading before and after a trade has been executed, comprising:
a. A software interface on said computerized device wherein said software interface enables multi-asset selection for algorithmic trading;
b. At least one computer grade server, comprising:
i. At least one processor;
ii. Non-transitory memory coupled to said at least one processor;
iii. Operating software by which to operate said computer grade server;
iv. A first algorithm for algorithmic trading, said computerized device being in untethered communication with said at least one computer grade server;
c. A second algorithm positioned onto said at least one computer grade server wherein said second algorithm comprises the steps of:
i. Identifying the trend of a current market direction;
ii. Choosing one or multiple of securities to trade;
iii. Identifying multiple trade options;
iv. Employing a machine learning engine for examining trend line motions of one or more subject securities having the steps of;
1. Collecting market data;
2. Forming a data set from said collected market data;
3. Producing an estimate about a pattern in said data set;
4. Making a prediction about said data set;
5. Evaluating said prediction;
6. Optimizing the prediction for accuracy;
v. Producing a stop/loss target for each said trade option based upon said prediction;
vi. Calculating a profit analysis for each said multiple trade options; and
vii. Choosing one or more of said multiple trade options to execute a trade of said security or securities within said system.

2. The machine learning enabled system for algorithmic trading of claim 1 further comprising a third algorithm wherein said third algorithm constantly monitors post trade market conditions of said chosen security or securities.

3. The machine learning enabled system for algorithmic trading of claim 2 wherein said third algorithm calculates a new stop/loss target based upon varying market conditions.

4. The machine learning enabled system for algorithmic trading of claim 3 wherein second algorithm autonomously executes a trade based upon said new stop/loss target calculated by said third algorithm.

5. The machine learning enabled system for algorithmic trading of claim 1 wherein a user chooses one or more assets to be traded.

6. The machine learning enabled system for algorithmic trading of claim 1 wherein a user chooses a trading strategy for trading assets.

7. The machine learning enabled system for algorithmic trading of claim 6 wherein said second algorithm chooses one or more assets to be traded based upon said trading strategy.

8. The machine learning enabled system for algorithmic trading of claim 1 wherein said system is self-adjusting based upon past and current market performance.

9. The machine learning enabled system for algorithmic trading of claim 1 wherein said system tracks and records each trade and attendant market condition for each trade as historical data and stores said historical data to memory in said one or more computer grade servers.

10. The machine learning enabled system for algorithmic trading of claim 9 wherein said system references said historical data for future evaluation for future trades by said system

11. The machine learning enabled system for algorithmic trading of claim 10 said system learns and adapts without following explicit user instructions.

12. The machine learning enabled system for algorithmic trading of claim 1 wherein said system creates a trading strategy for said chosen security or securities.

13. The machine learning enabled system for algorithmic trading of claim 12 wherein said system makes trades according to said created trading strategy for said chosen security or securities.

14. The machine learning enabled system for algorithmic trading of claim 1 wherein said system constantly monitors dynamic market conditions before and after said trade has been executed.

15. The machine learning enabled system for algorithmic trading of claim 14 wherein said system receives a first optimal profit target from said user prior to execution of said trade or trades.

16. The machine learning enabled system for algorithmic trading of claim 15 wherein said system autonomously calculates a second optimal profit target prior to execution of said trade or trades based upon said dynamic market conditions.

17. The machine learning enabled system for algorithmic trading of claim 16 wherein said system autonomously alters timing of a trade to achieve said second optimal profit prior to its execution based upon dynamic market conditions.

18. The machine learning enabled system for algorithmic trading of claim 17 wherein said system autonomously calculates a second optimal profit target after execution of said trade or trades based upon said dynamic market conditions.

19. The machine learning enabled system for algorithmic trading of claim 18 wherein said system autonomously executes a second trade to achieve said second optimal profit after execution of said system's first trade based upon dynamic market conditions.

20. The machine learning enabled system for algorithmic trading of claim 1 wherein said system is self-learning.

21. The machine learning enabled system for algorithmic trading of claim 20 comprising one or more trade inputs and machine learning.

22. The machine learning enabled system for algorithmic trading of claim 1 wherein said system creates multiple trading strategies based upon market conditions for said chosen security or securities.

23. The machine learning enabled system for algorithmic trading of claim 22 wherein a user initially chooses one of said multiple trading strategies with which to trade prior to execution of a trade.

24. The machine learning enabled system for algorithmic trading of claim 23 having a fourth algorithm wherein said fourth algorithm chooses between said multiple trading strategies after said user chooses initial trading strategy from said multiple trading strategies.

25. The machine learning enabled system for algorithmic trading of claim 24 constantly monitors varying market conditions after said trade has been executed.

26. The machine learning enabled system for algorithmic trading of claim 25 wherein said system continually calculates an optimal profit based upon said varying market conditions.

27. The machine learning enabled system for algorithmic trading of claim 26 wherein said system autonomously alters an executed trade based upon said optimal profit and said new trading strategy chosen by said fourth algorithm.

28. The machine learning enabled system for algorithmic trading of claim 27 wherein said system is self-learning.
